(19) United States
(12) Patent Application Publication
(10) Pub. No.: US 2007/0057864 A1
(43) Pub. Date: Mar. 15, 2007

(54) [MONO-FREQUENCY ANTENNA]

(75) Inventor: Churng-Jou Tsai, TAIPEI (TW)

Correspondence Address: ANTENNIQUES CORP. LTD., P. O. BOX 108-00403, TAIPEI, TW

(73) Assignee: ANTENNIQUES CORP. LTD., Shulin City, Taipei Hsian. (TW)

(21) Appl. No.: 11/162,462

(22) Filed: Sep. 11, 2005

(51) Int. Cl. H01Q 9/30

(52) U.S. Cl. 343/900; 343/702

(57) ABSTRACT

A mono-frequency antenna includes a holder base; a resonator, which includes a metal sleeve mounted in the holder base, a metal barrel axially spaced from the metal sleeve by a gap, and a metal conductor extended from one end of the metal barrel remote from the metal sleeve, the metal conductor having a coiled portion of 6˜25 turns and an outer diameter smaller than 4φ and a signal wire conductor portion extending from the coiled portion, wherein the signal wire conductor portion having a middle U-turn to increase the gain value; and a coaxial cable inserted through the holder base and electrically connected to the resonator.

### BACKGROUND OF THE INVENTION

1. Field of the Invention

The present invention relates to an antenna and more particularly, to a mono-frequency antenna, which has a U-shaped signal wire conductor portion that increases the gain value, for enabling the antenna to be used in an electronic product having light, thin, short and small characteristics.

2. Description of the Related Art

A regular ½ wavelength (½λ) dipole antennas, as shown in FIG. 5, comprises a positive pole and a negative pole (i.e., the signal pole and the grounding pole) respectively made of metal. The length of the two poles is about ¼ of the wavelength of the carrier frequency. This design of dipole antenna provides about 2.5 dbi radiation gain value under the carrier frequency of 2.45 GHz. The performance of the antenna is determined subject to the gain value. The greater the gain value is the farther the effective communication distance of the communication apparatus will be. However, the radiation gain value of this ½ wavelength (½λ) of the dipole antenna is insufficient to a communication apparatus that needs a longer effective communication distance.

FIG. 6 is a schematic drawing showing the structure of a conventional modified complex antenna. As illustrated, this modified complex antenna comprises a dipole antenna A, a spiral antenna B and a rod antenna C. The length of the dipole antenna A is ½ wavelength (½λ) of the carrier frequency. The length of the two poles of the dipole antenna A is ¼ wavelength (¼λ) of the carrier frequency. The positive (+) pole and the negative (−) pole of the dipole antenna A are connected by a coaxial cable A1. The positive pole of the dipole antenna A is connected to one end of the spiral antenna B. The length of the spiral antenna B is ½ wavelength (½λ) of the carrier frequency. The other end of the spiral antenna B is connected to the rod antenna C. The length of the rod antenna C is ⅝ wavelength (⅝λ). By means of the aforesaid arrangement, this modified complex antenna enables different communication apparatus to have a sufficient gain value for a long effective communication distance. However, because the dipole antenna A, the spiral antenna B and the rod antenna C are connected in series, this modified complex antenna has a long length. When used in an electronic product (such as a wireless switch, wireless network card), this modified complex antenna occupies much space. Therefore, this design of modified complex antenna is not suitable for use in an electronic product having light, thin, short and small characteristics. Further, due to the disadvantage of long length, the rod antenna C of this modified complex antenna tends to be damaged by an external force during delivery, resulting in a change of the signal receiving characteristic or malfunctioning of the antenna. Further, because the rod antenna C extends upwards for receiving signal, it makes little gain value enhancement. When the shape of the rod antenna C is changed, the modified complex antenna will receive a vague signal, and will not be able to provide the communication apparatus with a long effective communication distance.

Therefore, it is desirable to provide an antenna that eliminates the aforesaid drawbacks.

### SUMMARY OF THE INVENTION

The present invention has been accomplished under the circumstances in view. It is therefore the main object of the present invention to provide a mono-frequency antenna, which has means to enhance the resonant effect, obtaining a better gain value. It is another object of the present invention to provide a mono-frequency antenna, which is suitable for use in an electronic product having light, thin, short and small characteristics.

To achieve these and other objects of the present invention, the mono-frequency antenna comprises a holder base; a resonator fastened to the holder base for receiving signal, the resonator comprising a metal sleeve mounted in the holder base, a metal barrel axially spaced from the metal sleeve by a gap, and a metal conductor extended from one end of the metal barrel remote from the metal sleeve, the metal conductor of the resonator comprising a coiled portion extended from the metal barrel and a signal wire conductor portion extending from one end of the coiled portion remote from the metal barrel; and a coaxial cable inserted through the holder base and electrically connected to the resonator; wherein the signal wire conductor portion has a U-turn that enhances the gain value of the mono-frequency antenna.

### BRIEF DESCRIPTION OF THE DRAWINGS

FIG. 1 is an exploded view of a mono-frequency antenna according to the present invention.

FIG. 2 is a sectional exploded and partially assembled view of the mono-frequency antenna according to the present invention.

FIG. 3 is an elevational assembly view of the mono-frequency antenna according to the present invention.

FIG. 4 is a feedback loss chart of the mono-frequency antenna according to the present invention.

FIG. 5 is a schematic drawing showing the basic structure of a dipole antenna according to the prior art.

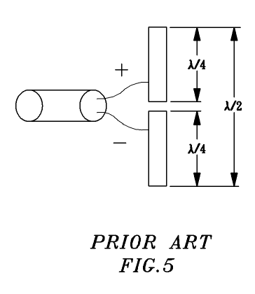

FIG. 6 is a schematic drawing showing the structure of a modified complex antenna according to the prior art.

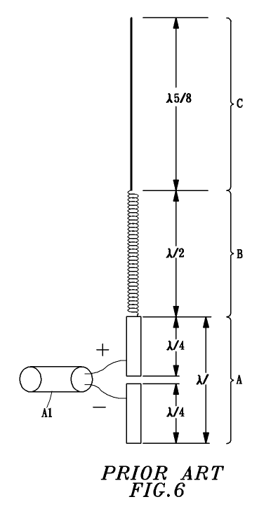

### DETAILED DESCRIPTION OF THE PREFERRED EMBODIMENT

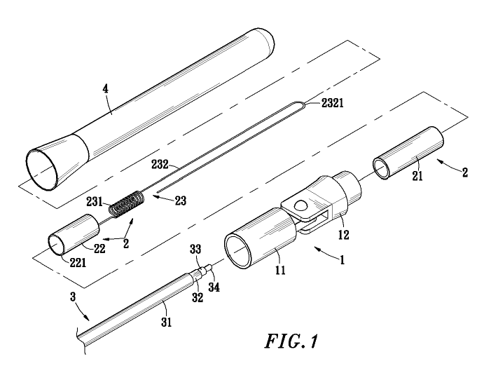

Referring to FIG. 1, a mono-frequency antenna in accordance with the present invention is shown comprised of a holder base 1, a resonator 2, a coaxial cable 3, and an induction shield 4.

The holder base 1 comprises a mounting shell 11, and a holder shell 12 rotatably and pivotally coupled to one end of the mounting shell 11.

The resonator 2 comprises a metal sleeve 21, a metal barrel 22, and a metal conductor 23. The metal sleeve 21 and the metal barrel 22 commonly have the length of λ/4 (wavelength). The outer diameter of the metal barrel 22 is smaller than 4φ (mm). The metal barrel 22 is axially spaced from the metal sleeve 21 by a fixed gap, which is smaller than 1/20λ. The metal barrel 22 has a bottom bonding edge 221 at the bottom end thereof. The metal conductor 23 is fixedly connected to the top end of the metal barrel 22 opposite to the bottom bonding edge 221, having a coiled portion 231 connected to the metal barrel 22 and a signal wire conductor portion 232 extending from one end of the coiled portion 231 opposite to the metal barrel 22. The number of turns of the coiled portion 231 is about 6˜25. The outer diameter of the coiled portion 231 is smaller than 4φ. The total length of the signal wire conductor portion 232 is about 0.4λ˜0.8λ. Further, the signal wire conductor portion 232 has a U-turn 2321 that enhances the gain.

The coaxial cable 3 comprises an outer insulative layer 31, a tubular braided conducting layer 32 surrounded by the outer insulative layer 31, an inner insulative layer 33 surrounded by the tubular braided conducting layer 32, and a center conductor 34 surrounded by the inner insulative layer 33.

The induction shield 4 is a hollow cylindrical shell made of electrically insulative material.

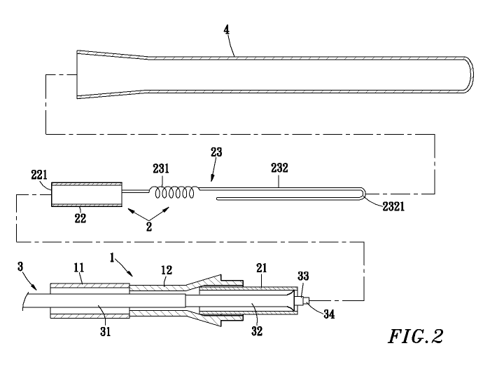

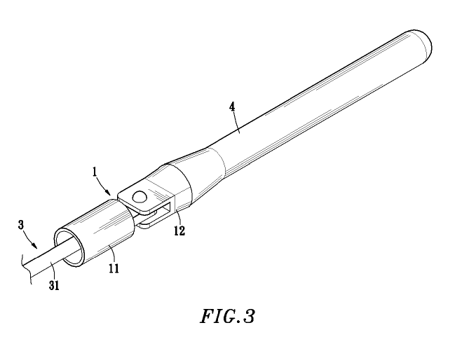

The assembly process of the antenna is simple and outlined hereinafter with reference to FIGS. 2 and 3 and FIG. 1 again. The metal sleeve 21 of the resonator 2 is fastened to the holder shell 12 of the holder base 1, and then the coaxial cable 3 is inserted through the mounting shell 11 and holder shell 12 of the holder base 1 and the metal sleeve 21 of the resonator 2 to have the center conductor 34 and the tubular braided conducting layer 32 of the coaxial cable 3 be bonded to the bonding edge 221 of the metal barrel 22 and the metal sleeve 21 respectively and to keep the bottom bonding edge 221 spaced from the holder shell 12 at a distance, and then the induction shield 4 is capped onto the resonator 2 and fixedly fastened to the holder shell 12.

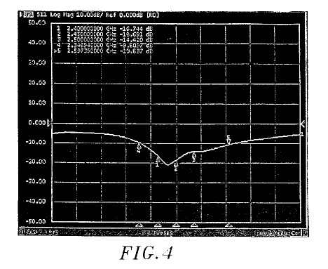

Referring to FIG. 4 and FIG. 1 again, when in use, the metal sleeve 21, metal barrel 22 and metal conductor 23 of the resonator 2 provide a frequency band to receive signal. The frequency band increases the amplitude and keeps the feedback loss below a predetermined value, thereby obtaining a stable signal. Received signal is transmitted from the resonator 2 to an electronic apparatus in which the mono-frequency antenna is installed via the coaxial cable 3. Further, the U-turn 2321 of the signal wire conductor portion 232 of the resonator 2 enhances the gain, preventing narrowing of the bandwidth. The induction shield 4 effectively amplifies the bandwidth. The resonant frequency of the mono-frequency antenna is practical for low frequency band 2.4 GHz˜2.5 GHz or high frequency band 4.9 GHz˜6 GHz. The aforesaid characteristics enable the mono-frequency antenna to be used in an electronic product having light, thin, short and small characteristics.

Further, for a high-frequency application, the mono-frequency antenna is preferably made having the gap between the bottom bonding edge 221 of the metal barrel 22 and the metal sleeve 21 to be less than 1/20λ, the metal sleeve 21, metal barrel 22 and metal conductor 23 of the resonator 2 to be respectively formed of copper, the length of the metal sleeve 21 as well as the length of the metal barrel 22 to be about λ/4, and the outer diameter of the metal barrel 22 to be less than 4φ.

As indicated above, the invention provides a mono-frequency antenna, which has the signal wire conductor portion of the metal conductor of the resonator made to provide a U-turn that enhances the resonant effect to obtain a high gain value, therefore the mono-frequency antenna is suitable for use in an electronic product having light, thin, short and small characteristics.

A prototype of mono-frequency antenna has been constructed with the features of FIGS. 1˜4. The mono-frequency antenna functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A mono-frequency antenna comprising
a holder base;
a resonator fastened to said holder base for receiving signal, said resonator comprising a metal sleeve mounted in said holder base, a metal barrel axially spaced from said metal sleeve by a gap, and a metal conductor extended from one end of said metal barrel remote from said metal sleeve, said metal conductor of said resonator comprising a coiled portion extended from said metal barrel and a signal wire conductor portion extending from one end of said coiled portion remote from said metal barrel; and
a coaxial cable inserted through said holder base and electrically connected to said resonator;
wherein said signal wire conductor portion has a U-turn at a middle part thereof that enhances the gain value of the mono-frequency antenna.

2. The mono-frequency antenna as claimed in claim 1, wherein said coaxial cable comprises an outer insulative layer, a tubular braided conducting layer bonded to said metal sleeve and surrounded by said outer insulative layer, an inner insulative layer surrounded by said tubular braided conducting layer, and a center conductor bonded to said metal barrel and surrounded by said inner insulative layer.

3. The mono-frequency antenna as claimed in claim 1, wherein said metal sleeve, said metal barrel and said metal conductor of said resonator are made of copper.

4. The mono-frequency antenna as claimed in claim 1, wherein said holder base comprises an electrically insulative mounting shell for mounting, and an electrically insulative holder shell rotatably and pivotally coupled to one end of said mounting shell and adapted to hold said metal sleeve of said resonator.

5. The mono-frequency antenna as claimed in claim 1, further comprising an electrically insulative induction shield capped on said resonator and affixed to said holder shell of said holder base.

6. The mono-frequency antenna as claimed in claim 1, wherein said metal sleeve and said metal barrel commonly have a length of λ/4 (wavelength); said metal barrel has an outer diameter less than 4φ (mm).

7. The mono-frequency antenna as claimed in claim 1, wherein said gap between said metal barrel and said metal sleeve is less than 1/20λ.

8. The mono-frequency antenna as claimed in claim 1, wherein said coiled portion of said metal conductor of said resonator has 6˜25 turns, and an outer diameter of said coiled portion of said metal conductor of said resonator is less than 4φ.

9. The mono-frequency antenna as claimed in claim 1, wherein a total length of said signal wire conductor portion of said metal conductor of said resonator is within 0.4λ˜0.8λ.
